(19) United States
(12) Patent Application Publication
(10) Pub. No.: US 2008/0281707 A1
(43) Pub. Date: Nov. 13, 2008

(54) Sales Compensation Management Software

(75) Inventors: Sean McGinty, Hudson, MA (US); Elizabeth Cobb, Chestnut Hill, MA (US)

Correspondence Address: BROMBERG & SUNSTEIN LLP, 125 SUMMER STREET, BOSTON, MA, 02110-1618, US

(73) Assignee: MAKANA SOLUTIONS, INC., Lexington, MA (US)

(21) Appl. No.: 12/116,443

(22) Filed: May 7, 2008

Related U.S. Application Data
(60) Provisional application No. 60/916,463, filed on May 7, 2007.

(51) Int. Cl. G06Q 30/00

(52) U.S. Cl. 705/14

(57) ABSTRACT

Incentive-based compensation plans are described. Associated compensation components are described for various organizational job positions. Each compensation component has an associated set of compensation-related characteristics. A visual representation of the job positions and their associated compensation components is displayed along with corresponding compensation components of different job positions which are located adjacent to each other. An incentive-based compensation arrangement is developed for each of the job positions based on the visual representation together with performance crediting rules and payment rules.

This application claims priority from U.S. Provisional Patent Application 60/916,463, filed May 7, 2007, which is incorporated herein by reference.

### FIELD OF THE INVENTION

The present invention relates to the field of designing and calculating incentive compensation plans for sales representatives and teams or any other job role paid an incentive based on one or more transactions.

### BACKGROUND ART

Multiple constituents across an organization affect or are affected by compensation plan designs and compensation plan administration. For example, such constituencies include compensation professionals such as compensation designers, compensation managers, compensation administrators; sales personnel such as sales management and sales representatives; executive management; finance/payroll; legal; Information Technology personnel; and administrative implementation services (internal and external).

For example, FIG. 1 shows one view of various organizational elements with respect to incentive based compensation. Initially, a Compensation Planning Function 100 is performed. Employee updates are determined from a Human Resources Information System (HRIS) 102. In addition, Customer Relationship Management (CRM) Pipelines 103 inputs projections into the model. A Spreadsheet Model 104 is produced for each job position (sales roles) and estimate costs based relative attainment. These resources are used to develop Plan Rules 101 for production.

These Plan Rules 101 are used in Sales Compensation Systems 106 as part of a Production Administration Function 105 to calculate compensation using spreadsheet and/or database tools. Besides the Plan Rules 101, the Compensation Calculation 107 typically takes into account Crediting Rules 108 that reflect objective job performance data, which in the case of sales positions, might include Enterprise Resource Planning (ERP) Data 109 such as orders, invoices, etc., and Channel Sales Data 110 such as invoices, etc. Based on the calculations of the Plan Rules 101 and Crediting Rules 108, compensation decisions are made and Compensation Communicated 111 to organizational payroll to provide the determined compensation and payment to each individual.

### SUMMARY OF THE INVENTION

Embodiments of the present invention are directed to incentive-based compensation plans. Associated compensation components are described for various organizational job positions. Each compensation component has an associated set of compensation-related characteristics. A visual representation of the job positions and their associated compensation components is displayed along with corresponding compensation components of different job positions which are located adjacent to each other. An incentive-based compensation arrangement is developed for each of the job positions based on the visual representation together with performance crediting rules and payment rules.

In further specific embodiments, the compensation components may include a summary element, a measurement element, and a formula element. For example, the measurement element may include compensation components for the associated job position which reflect a performance contribution to organizational performance goals. Embodiments may also further use the developed visual representation to assess job performance. The performance crediting rules may be based on at least one of enterprise resource planning (ERP) data and channel sales data. The crediting rules may also reference specific organization relationships and custom tables (e.g. product, customer, tiered weights, etc.).

### BRIEF DESCRIPTION OF THE DRAWINGS

FIG. 1 shows one view of various organization elements with respect incentive based compensation.

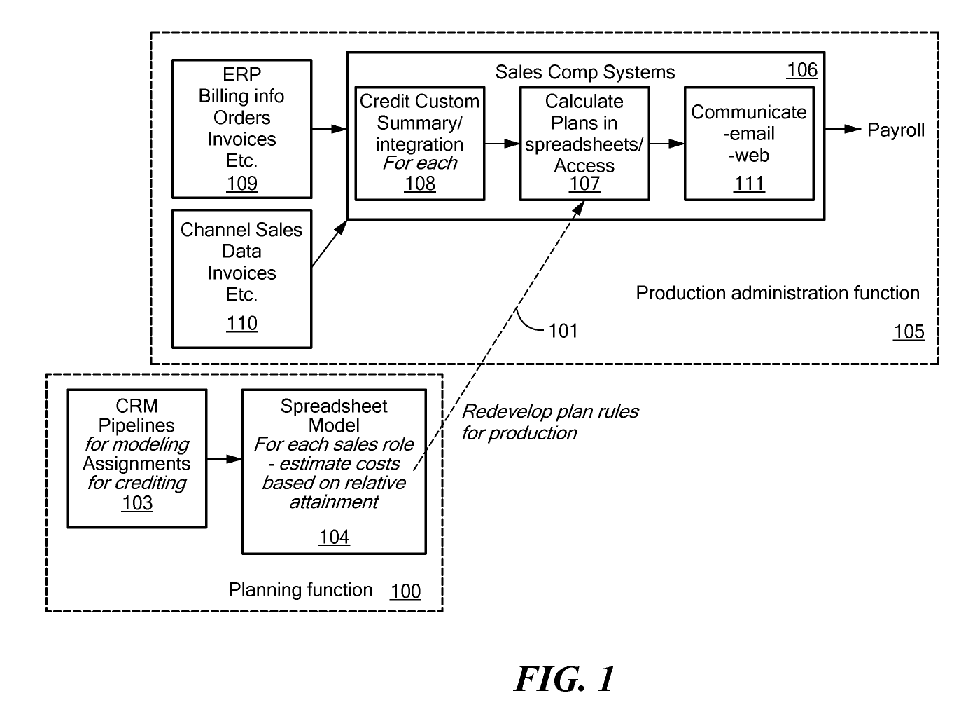

FIG. 2 illustrates combining of relevant planning and payment functions to define common compensation functions.

FIG. 3 shows an example of an interface display for one specific incentive-based compensation plan.

FIG. 4 shows comparison of plan elements and characteristics between different job positions.

FIG. 5 illustrates various aspects of the credit rules language and rate structure.

FIG. 6 shows an example such a form useful to add and delete credit rules.

FIG. 7 shows an example of a full description of the credit rules language for one specific embodiment.

### DETAILED DESCRIPTION OF SPECIFIC EMBODIMENTS

Embodiments of the present invention are based on a unifying view of basic incentive-based compensation plan elements across multiple organizational job positions. Display elements encapsulate information about various portions of the compensation plan. This enables common rule definitions between modeling and administration, and also supports the ability to calculate compensation results using either abstract variable attainment or detailed actual attainment.

Embodiments of the present invention provide systems, methods and computer programs for designing, calculating, and administrating incentive-based compensation plans. Specific embodiments employ a modeling component and an administrative component to support various job positions and perform a full cycle of incentive compensation management from planning to payment. Embodiments include a compensation plan display to show how the various components will work together. The display interface and the various rules for compensation plan creation are shared between modeling and the administration systems. This simplifies moving from planning to implementation of on-going payment and reporting. The display interface allows a user to capture the structure and rules of a given incentive-based compensation plan by using a series of forms to determine incentive payments. Embodiments include a credit rules language that may be automatically created by the forms to map orders, invoices, or other transactions to the job position of an appropriate plan participant. The credit rules language is precise but can be understood by a non-technical compensation administrator.

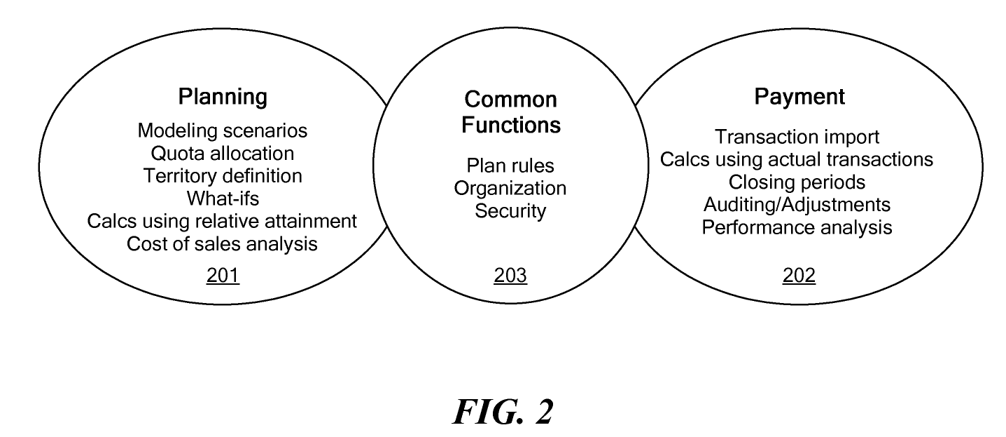

FIG. 2 illustrates combining of relevant planning functions 201 and payment functions 202 to define common compensation functions 203. From planning functions 201, various illustrative considerations include without limitation modeling scenarios, quota allocation, territory definition, what-if hypotheticals, calculations using relative attainment, and cost of sales analysis. Payment considerations 202 are also taken into account, for example, factors such as transaction import, calculations using actual transactions, closing periods, auditing/adjustment factors, and performance analysis. By integrating and synthesizing together the planning and payment inputs, a set of common compensation functions 203 can be defined which reflect plan rules, organizational factors, and security considerations.

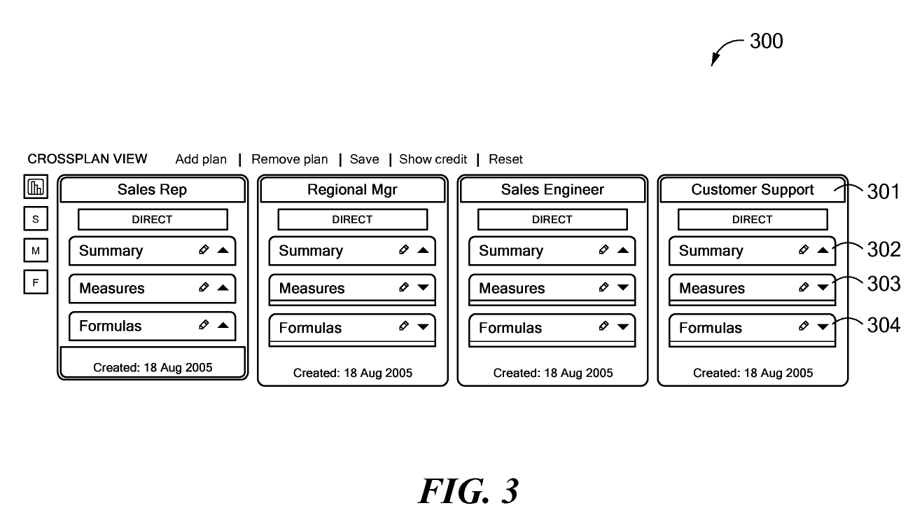

Specific embodiments of the present invention include incentive-based compensation plans based on defining associated compensation components for various organizational job positions. FIG. 3 shows an example of an interface display 300 for one such plan in which the defined compensation components for each organization job position 301 include three specific elements: summary 302, measures 303, and formulas 304. Each compensation component has an associated set of compensation-related characteristics.

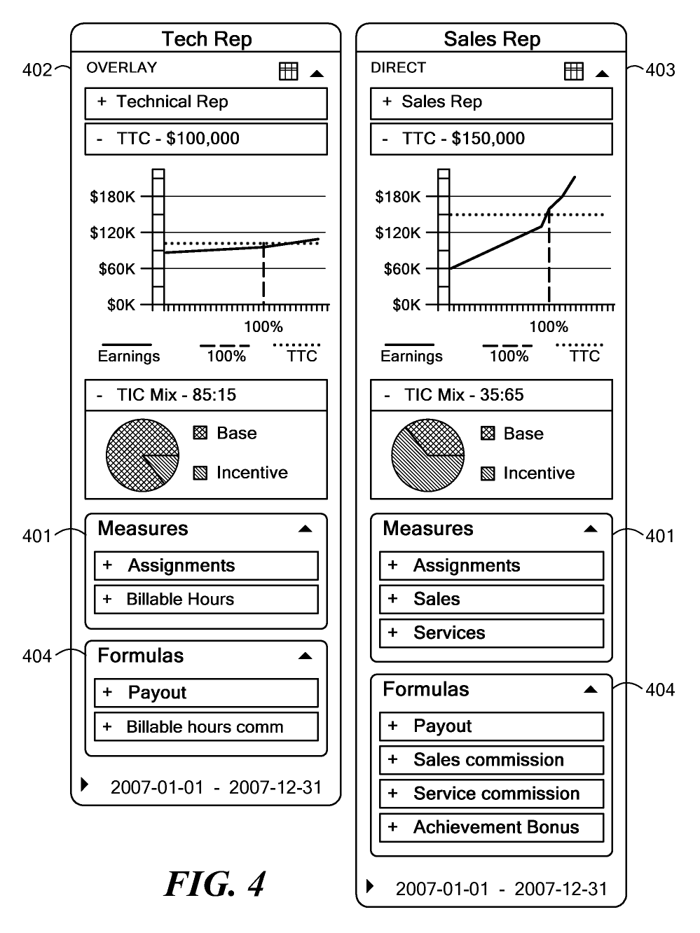

In the example shown in FIG. 4, the compensation related characteristics for the measures element 401 for the tech rep job position 402 reflects a performance contribution to organizational performance goals and includes Assignments and Billable Hours, while the measures element 401 for the sales rep job position 403 includes Assignments, Sales, and Service. Thus, the measures element 401 in particular and the visual representation generally are useful to assess job performance associated with a given job position. The measures element 401 determines a basis of attainment to calculate incentive payments. Specific measures elements 401 will have associated goals, quotas or expected attainments assigned to them so that the compensation planner can perform hypothetical what-if scenarios with attainment assumptions without detailed transactions. A given measure's element 401 can be expanded to include business rules necessary to identify and accumulate actual attainment for production pay calculations.

It may be especially useful as shown in FIGS. 3 and 4 to conceptually separate the measures element 401 from the formulas element 404 in the plan pods. This improves the capability of the system to calculate costs or payments using the same mechanism for various job positions based on relative attainment of performance goals.

As shown in FIGS. 3 and 4, once the various compensation components have been defined, embodiments then display a visual representation of the job positions 301 and their associated compensation components so that corresponding compensation components of different job positions are located adjacent to each other. So in FIG. 3, four job positions 301 are defined-sales rep, regional manager, sales engineer, and customer support—and for each of these job positions the compensation components are displayed adjacent to each other: the summary elements are all mutually adjacent, as are the measures elements and the formulas elements. Of course this adjacency correspondence need not necessarily be strictly observed, as in FIG. 4, where the overlay/direct elements are completely adjacent to each other, but the measures elements 401 and the formulas elements 404 are slightly offset to accommodate differences in their respective compensation-related characteristics.

The adjacent display elements are then useful for developing an incentive-based compensation arrangement for each of the job positions based the visual representation together with performance crediting rules and payment rules. That is, the plan elements for each job position are visually combined into a plan pod, and elements and rules belonging to a specific job position can be viewed together. The plan pods can be opened and closed as a group so that compensation components are comparable across job positions, thereby helping the plan designer to compare plan elements and compensation components for factors such as:

Fairness or equity

Conflicts of interest between job roles

Mix of base pay to incentive pay

Amount of leverage of earnings for at risk pay.

Thus, drilling down into compensation component elements reveals the specific rules used for incentive-based compensation calculations. One situation in which this is useful is in using the display view and its display of job positions, compensation components, compensation-related characteristics, performance crediting rules and payment rules to actually calculate the incentives for each job position and each pay cycle.

In order to calculate incentives each pay cycle, the system credits the sales transactions to a given job position and calculates incentives based on varying rates and rules that are applied to the measures. For that, a credit rules language and a formula builder can be created through display forms which are then parsed by the administration system to complete the calculations.

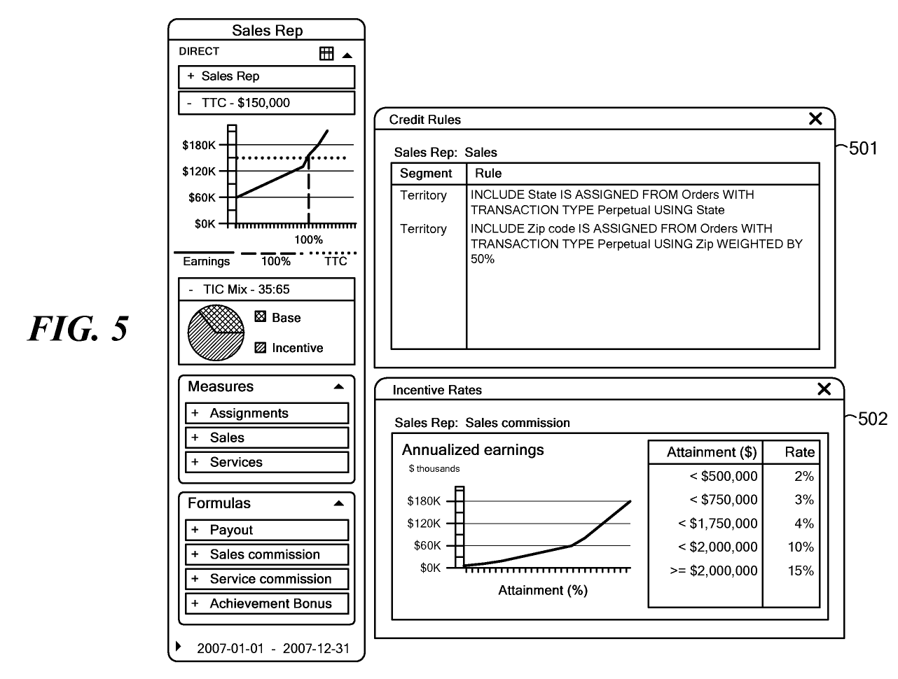

FIG. 5 illustrates various aspects of the credit rules language 501 and incentive rate structure 502. The credit rules language 501 in the embodiment shown is simple and readily understood by compensation planners. The credit rules can be used in combination to support arbitrarily complex compensation plans which may pull data from multiple sources and have varying weighting factors. The credit rules can be configured through standard display forms with drop down selections that can be configured at implementation by the client.

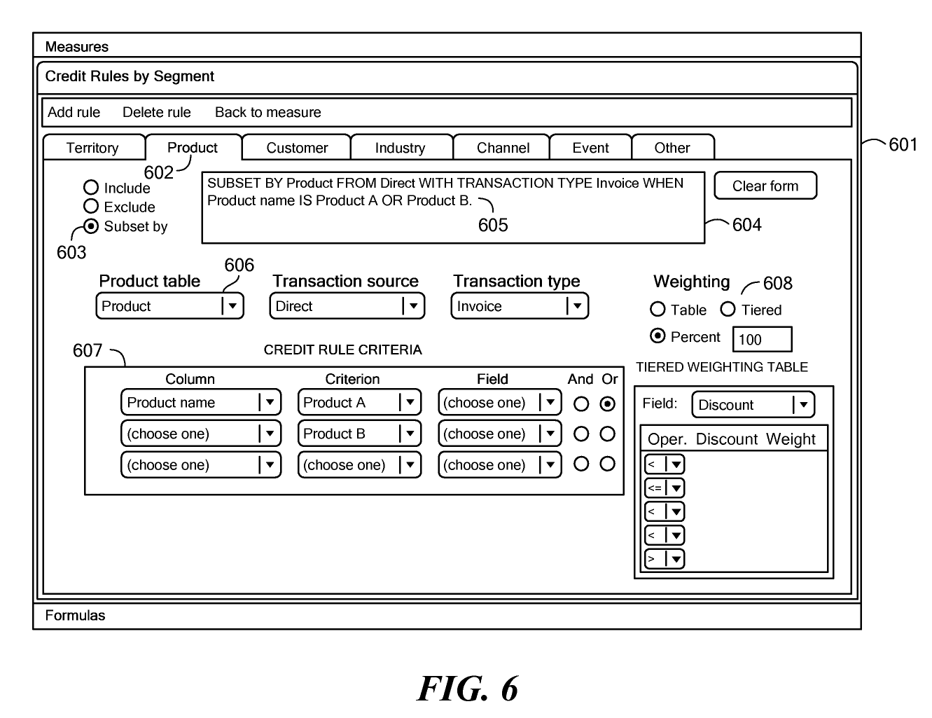

FIG. 6 shows an example such a credit rules form 601 useful to add and delete credit rules. The credit rule form 601 is shown selected to a product tab 602 which has radio selector buttons 603 in the upper left to allow specifying a given rule as an include rule, and exclude rule, or a subset by rule, with a text box 604 to the right to allow the specific product rule 605 to be expressed. Drop selections 606 are available for specifying a product table source, transaction source, and transaction type. The bottom of the product tab 602 has a credit rule criteria area 607 with drop down selectors for various specific rule criteria. The lower right side of the product tab 602 has a weighting area 608 for specifying rule weighting, etc. As shown, a credit rules form 601 may contain similar selectable tabs for Territory, Customer, Industry, Channel, Event, and Other credit rules to be controlled.

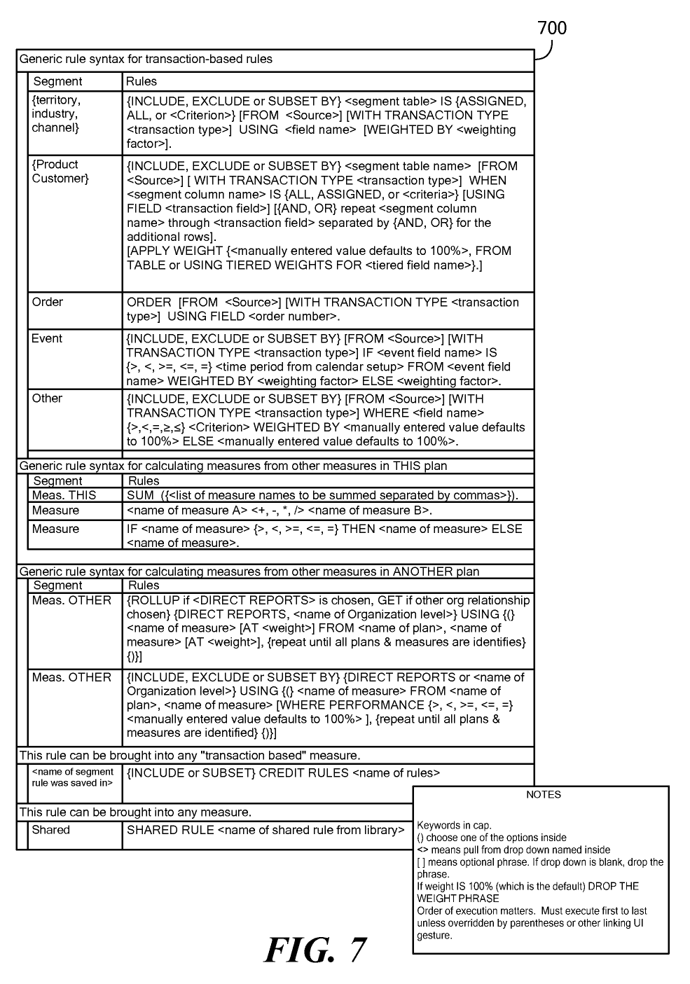

FIG. 7 shows an example of a full description of the credit rules language 700 for one specific embodiment. The embodiment shown allows credit rules to be formulated using segment-based generic rule syntax constraints.

Embodiments of the invention may be implemented in any conventional computer programming language. For example, preferred embodiments may be implemented in a procedural programming language (e.g., “C”), an object oriented programming language (e.g., “C++”, Java, Python), or functional language (e.g., Haskell, Lisp). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, DVD, or fixed disk) or transmittable to a computer system, via a modem, DSL, ADSL, ISDN or other interface device, such as a communications adapter connected to a network over a medium. The medium may be either a tangible medium (e.g., optical, digital, or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM, DVD, or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of determining incentive-based compensation comprising:
defining associated compensation components for a plurality of organizational job positions, each compensation component having an associated set of compensation-related characteristics;
displaying a visual representation of the job positions and their associated compensation components with corresponding compensation components of different job positions being located adjacent to each other;
developing an incentive-based compensation arrangement for each of the job positions based on the visual representation together with performance crediting rules and payment rules.

2. A method according to claim 1, wherein the compensation components include a summary element, a measurement element, and a formula element.

3. A method according to claim 2, wherein the measurement element includes compensation components for the associated job position reflecting a performance contribution to organizational performance goals.

4. A method according to claim 1, further comprising:
using the developed visual representation to assess job performance.

5. A method according to claim 1, wherein the performance crediting rules are based on at least one of enterprise resource planning (ERP) data and channel sales data.

6. An incentive based compensation plan development tool comprising:
a plurality of associated compensation components for a plurality of organizational job positions, each compensation component having an associated set of compensation-related characteristics;
a display element for displaying a visual representation of the job positions and their associated compensation components with corresponding compensation components of different job positions being located adjacent to each other;
a compensation calculation component for developing an incentive-based compensation arrangement for each of the job positions based on the visual representation together with performance crediting rules and payment rules.

7. A development tool according to claim 6, wherein the compensation components include a summary element, a measurement element, and a formula element.

8. A development tool according to claim 7, wherein the measurement element includes compensation components for the associated job position reflecting a performance contribution to organizational performance goals.

9. A development tool according to claim 6, further comprising:
a performance assessment component for using the developed visual representation to assess job performance.

10. A development tool according to claim 6, wherein the performance crediting rules are based on at least one of enterprise resource planning (ERP) data and channel sales data.

11. A computer program product in a computer readable storage medium for determining incentive-based compensation, the product comprising:
program code for defining associated compensation components for a plurality of organizational job positions, each compensation component having an associated set of compensation-related characteristics;
program code for displaying a visual representation of the job positions and their associated compensation components with corresponding compensation components of different job positions being located adjacent to each other;
program code for developing an incentive-based compensation arrangement for each of the job positions based on the visual representation together with performance crediting rules and payment rules.

12. A computer program product according to claim 11, wherein the compensation components include a summary element, a measurement element, and a formula element.

13. A computer program product according to claim 12, wherein the measurement element includes compensation components for the associated job position reflecting a performance contribution to organizational performance goals.

14. A computer program product according to claim 11, further comprising:
using the developed visual representation to assess job performance.

15. A computer program product according to claim 11, wherein the performance crediting rules are based on at least one of enterprise resource planning (ERP) data and channel sales data.
